(19) United States
(12) Patent Application Publication
(10) Pub. No.: US 2019/0079627 A1
(43) Pub. Date: Mar. 14, 2019

(54) DISPLAY SUBSTRATE, DISPLAY PANEL, DISPLAY DEVICE AND CONTROL METHOD THEREOF

(71) Applicant: BOE TECHNOLOGY GROUP CO., LTD., Beijing (CN)

(72) Inventors: Xiaoliang Ding, Beijing (CN); Xue Dong, Beijing (CN); Haisheng Wang, Beijing (CN); Yingming Liu, Beijing (CN); Yuzhen Guo, Beijing (CN); Wei Liu, Beijing (CN); Liguang Deng, Beijing (CN)

(73) Assignee: BOE TECHNOLOGY GROUP CO., LTD., Beijing (CN)

(21) Appl. No.: 15/928,525

(22) Filed: Mar. 22, 2018

(30) Foreign Application Priority Data
Sep. 8, 2017 (CN) 201710804825.2

(51) Int. Cl. G06F 3/041

(52) U.S. Cl. CPC G06F 3/0414; G06F 3/0412

(57) ABSTRACT

The present disclosure provides a display substrate, a display panel, a display device and a control method thereof. The display substrate includes a first conductive pattern arranged on a base substrate, and a pressure sensing structure arranged on the base substrate. The pressure sensing structure includes a first pressure sensing electrode, a second pressure sensing electrode and a piezoelectric layer arranged between the first pressure sensing electrode and the second pressure sensing electrode. The first conductive pattern is multiplexed as the first pressure sensing electrode, or the first conductive pattern is created from a layer and by a material both identical to the first pressure sensing electrode.

### CROSS-REFERENCE TO RELATED APPLICATION

The present application claims a priority of the Chinese patent application No. 201710804825.2 filed on Sep. 8, 2017, which is incorporated herein by reference in its entirety.

### TECHNICAL FIELD

The present disclosure relates to the field of display technology, in particular to a display substrate with an integrated pressure sensing function, a display panel, a display device and a control method thereof.

### BACKGROUND

As important function in the field of display sensing, a pressure sensing function is achieved through integrating a pressure sensor into a display device. In the related art, usually the pressure sensor and the display device are manufactured separately, and then the pressure sensor is formed on a back plate of the display device. In addition, in order to improve the sensitivity of the pressure sensor, a spacer is further arranged between the back plate of the display device and the pressure sensor, resulting in a relatively large thickness of the display device with the integrated pressure sensor as well as a complex structure.

### SUMMARY

In one aspect, the present disclosure provides in some embodiments a display substrate, including a first conductive pattern arranged on a base substrate, and a pressure sensing structure arranged on the base substrate. The pressure sensing structure includes a first pressure sensing electrode, a second pressure sensing electrode and a piezoelectric layer arranged between the first pressure sensing electrode and the second pressure sensing electrode. The first conductive pattern is multiplexed as the first pressure sensing electrode, or the first conductive pattern is created from a layer and by a material both identical to the first pressure sensing electrode.

In a possible embodiment of the present disclosure, a driving thin film transistor (TFT) of the display substrate is a Low Temperature Poly-Silicon (LTPS) TFT, and the first conductive pattern is a light-shielding metal layer pattern for shielding back light from entering the driving TFT.

In a possible embodiment of the present disclosure, the display substrate further includes a second conductive pattern arranged at a layer different from the first conductive pattern, and the second conductive pattern is multiplexed as the second pressure sensing electrode or the second conductive pattern is created from a layer and by a material both identical to the second pressure sensing electrode.

In a possible embodiment of the present disclosure, the second conductive pattern is a gate line or data line of the display substrate.

In a possible embodiment of the present disclosure, the first pressure sensing electrode includes rectangular or triangular sub-electrodes arranged in a matrix form.

In a possible embodiment of the present disclosure, the first pressure sensing electrode includes lateral sub-electrodes arranged in rows and vertical sub-electrodes arranged in columns, the adjacent lateral sub-electrodes are connected to each other via a conductive line arranged at a layer identical to the first pressure sensing electrode, and the adjacent vertical sub-electrodes are connected to each other via a bridge arranged at a layer different from the first pressure sensing electrode.

In a possible embodiment of the present disclosure, the bridge is created from a gate metal layer or a source/drain metal layer.

In a possible embodiment of the present disclosure, the bridge is created from a separate metal layer.

In a possible embodiment of the present disclosure, the piezoelectric layer is made of polyvinylidene fluoride.

In a possible embodiment of the present disclosure, the display substrate further includes a display electrode multiplexed as a touch electrode.

In another aspect, the present disclosure provides in some embodiments a display substrate, including, from bottom to top, a base substrate, a light-shielding metal layer, a piezoelectric layer, an insulation layer, an active layer, a gate insulation layer, and a gate metal layer. The piezoelectric layer is in contact with the light-shielding metal layer, and the light-shielding metal layer, the piezoelectric layer and the gate metal layer form a pressure sensing structure.

In yet another aspect, the present disclosure provides in some embodiments a display panel including the above-mentioned display substrate.

In still yet another aspect, the present disclosure provides in some embodiments a display device including the above-mentioned display panel.

In still yet another aspect, the present disclosure provides in some embodiments a method for controlling the above-mentioned display device, including steps of: applying a first reference electric signal to the first pressure sensing electrode and applying a second reference electric signal to the second pressure sensing electrode, a predetermined voltage difference being provided between the first reference electric signal and the second reference electric signal; and detecting a pressure sensing signal generated on the first pressure sensing electrode and/or the second pressure sensing electrode.

In a possible embodiment of the present disclosure, in the case that the light-shielding metal layer pattern is multiplexed as the first pressure sensing electrode and the gate line or data line of the display substrate is multiplexed as the second pressure sensing electrode, the method includes: at a display stage within each frame, not applying an electric signal to the first pressure sensing electrode and applying a display electric signal to the second pressure sensing electrode; and at a pressure detection stage within each frame, applying the first reference electric signal to the first pressure sensing electrode, and applying the second reference electric signal to the second pressure sensing electrode.

In a possible embodiment of the present disclosure, in the case that the light-shielding metal layer pattern for shielding back light from entering a driving TFT of the display substrate is multiplexed as the first pressure sensing electrode , the gate line or data line of the display substrate is multiplexed as the second pressure sensing electrode and the display electrode of the display substrate is multiplexed as the touch electrode, the method includes: at the display stage within each frame, applying a display voltage signal to the display electrode, not applying an electric signal to the first pressure sensing electrode, and applying a display electric signal to the second pressure sensing electrode; at a touch stage within each frame, applying a touch signal to the display electrode, and not applying an electric signal to the first pressure sensing electrode and the second pressure sensing electrode; and at the pressure detection stage within each frame, not applying an electric signal to the display electrode, applying the first reference electric signal to the first pressure sensing electrode, and applying the second reference electric signal to the second pressure sensing electrode.

### BRIEF DESCRIPTION OF THE DRAWINGS

FIG. 1 is a schematic view showing a display substrate according to one embodiment of the present disclosure;

FIGS. 2 to 4 are schematic views showing a first pressure sensing electrode according to one embodiment of the present disclosure;

FIG. 5 is a schematic view showing a bridge created from a separate metal layer according to one embodiment of the present disclosure;

FIG. 6 is a schematic view showing the bridge created from a gate metal layer according to one embodiment of the present disclosure;

FIG. 7 is an another schematic view showing the display substrate according to one embodiment of the present disclosure; and

FIG. 8 is a sequence diagram of a display device according to one embodiment of the present disclosure.

### DETAILED DESCRIPTION OF THE EMBODIMENTS

In order to make the objects, the technical solutions and the advantages of the present disclosure more apparent, the present disclosure will be described hereinafter in a clear and complete manner in conjunction with the drawings and embodiments. Obviously, the following embodiments merely relate to a part of, rather than all of, the embodiments of the present disclosure, and based on these embodiments, a person skilled in the art may, without any creative effort, obtain the other embodiments, which also fall within the scope of the present disclosure.

An object of the present disclosure is to provide a display substrate integrated with a pressure sensing function, a display device and a control method thereof, so as to solve the problem in the related art where a display device integrated with a pressure sensor has a relatively large thickness and a complex structure.

The present disclosure provides in some embodiments a display substrate, including a first conductive pattern arranged on a base substrate, and a pressure sensing structure arranged on the base substrate. The pressure sensing structure includes a first pressure sensing electrode, a second pressure sensing electrode and a piezoelectric layer arranged between the first pressure sensing electrode and the second pressure sensing electrode. The first conductive pattern is multiplexed as the first pressure sensing electrode, or the first conductive pattern is created from a layer and by a material both identical to the first pressure sensing electrode.

According to the embodiments of the present disclosure, the display substrate includes the first conductive pattern arranged on the base substrate. The first conductive patter is multiplexed as the first pressure sensing electrode or created from a layer and by a material both identical to the first pressure sensing electrode. In this way, it is able for a pressure sensing unit to be built in the display substrate, i.e., it is unnecessary to attach the pressure sensing unit onto the display device. As a result, it is able to provide the display substrate integrated with the pressure sensing function, thereby to simplify a structure of the display substrate and provide a thin and light display device.

In a possible embodiment of the present disclosure, a driving TFT of the display substrate is an LTPS TFT, and a light-shielding metal layer pattern is arranged on the base substrate so as to shield back light from entering the driving TFT. In this way, it is able to prevent an LTPS active layer of the driving TFT from being adversely affected by the back light, thereby to prevent the performance of the driving TFT from being adversely affected. In the embodiments of the present disclosure, the light-shielding metal layer pattern for shielding the back light from entering the driving TFT may be multiplexed as the first pressure sensing electrode, or the first pressure sensing electrode may be created from a layer and by a material both identical to the light-shielding metal layer pattern, i.e., the first conductive pattern is the light-shielding metal layer pattern for shielding the back light from entering the driving TFT.

In a possible embodiment of the present disclosure, the display substrate further includes a second conductive pattern arranged at a layer different from the first conductive pattern, and the second conductive pattern is multiplexed as the second pressure sensing electrode or the second conductive pattern is created from a layer and by a material both identical to the second pressure sensing electrode. In this way, it is able for the pressure sensing unit to be fully built in the display substrate, thereby to further simplify the structure of the display substrate and provide a more thin and light display device.

In a possible embodiment of the present disclosure, the second conductive pattern may be a gate line or a data line of the display substrate, or created from a layer and by a material both identical to the gate line or data line of the display substrate.

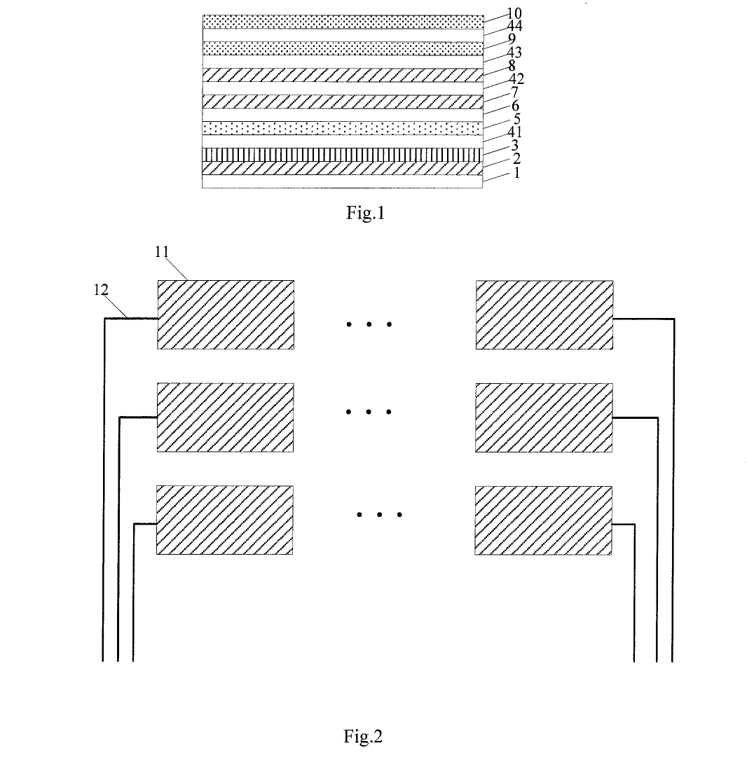

As shown in FIG. 1, the display substrate includes a light-shielding metal layer 2, a piezoelectric layer 3, an insulation layer 41, an active layer 5, a gate insulation layer 6, a gate metal layer 7, an insulation layer 42, a source/drain metal layer 8, an insulation layer 43, a common electrode layer 9, an insulation layer 44 and a pixel electrode layer 10 sequentially arranged on a base substrate 1. As compared with a conventional display substrate, merely the additional piezoelectric layer 3 is arranged on the display substrate, and the display substrate integrated with the pressure sensing function may be acquired merely through the first pressure sensing electrode, the second pressure sensing electrode and the original conductive layers of the display substrate.

In a possible embodiment of the present disclosure, the first pressure sensing electrode may be created from the light-shielding metal layer 2, the second pressure sensing electrode may be created from the gate metal layer 7, and the first pressure sensing electrode, the second pressure sensing electrode and the piezoelectric layer 3 may form the pressure sensing structure. In a possible embodiment of the present disclosure, the first pressure sensing electrode may be created from the light-shielding metal layer 2, and the second pressure sensing electrode may be created from the source/drain metal layer 8.

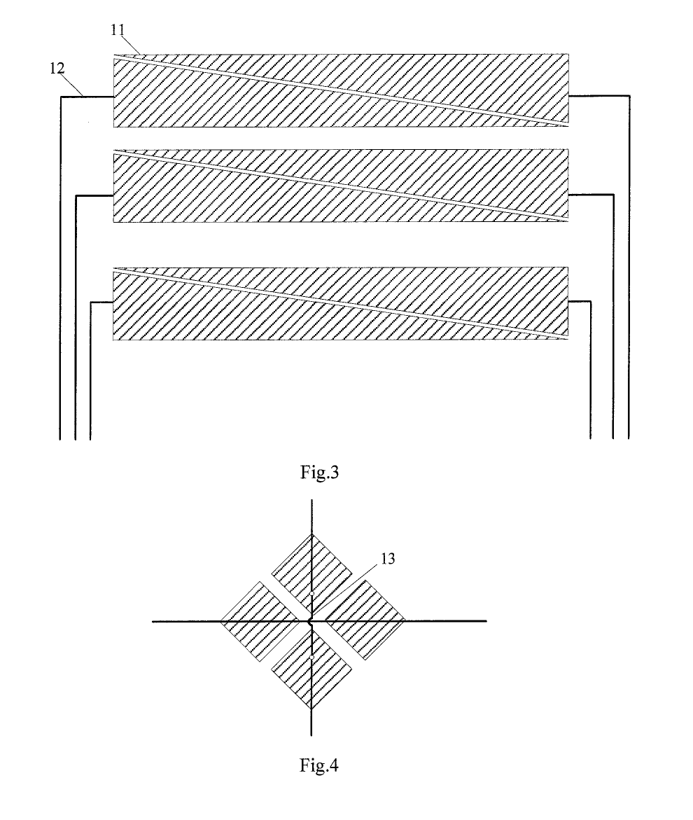

A shape of each pressure sensing electrode may be designed in accordance with the practical need. In a possible embodiment of the present disclosure, as shown in FIG. 2, the first pressure sensing electrode may include rectangular sub-electrodes 11 arranged in a matrix form and each connected to a pressure sensing signal line 12. In another possible embodiment of the present disclosure, as shown in FIG. 3, the first pressure sensing electrode may include triangular sub-electrodes 11 arranged in a matrix form and each connected to the pressure sensing signal line 12. It is able to transmit a pressure sensing signal to a pressure detection circuit via the pressure sensing signal line 12, so as to sense and identify a pressure.

As shown in FIGS. 2 and 3, the sub-electrodes 11 are each of a regular shape and arranged in a matrix form. In this way, it is able to provide the sub-electrodes 11 as many as possible, thereby to improve the pressure detection accuracy.

In a possible embodiment of the present disclosure, in order to reduce the number of the pressure sensing signal lines 12, as shown in FIG. 4, the first pressure sensing electrode may further include lateral sub-electrodes 11 arranged in rows and vertical sub-electrodes 11 arranged in columns, the adjacent lateral sub-electrodes 11 may be connected to each other via a conductive line arranged at a layer identical to the first pressure sensing electrode, and the adjacent vertical sub-electrodes 11 may be connected to each other via a bridge 13 arranged at a layer different from the first pressure sensing electrode. In the embodiments of the present disclosure, a row direction may refer to a direction identical to an extension direction of the gate line of the display substrate, and a column direction may refer to a direction identical to an extension direction of the data line of the display substrate.

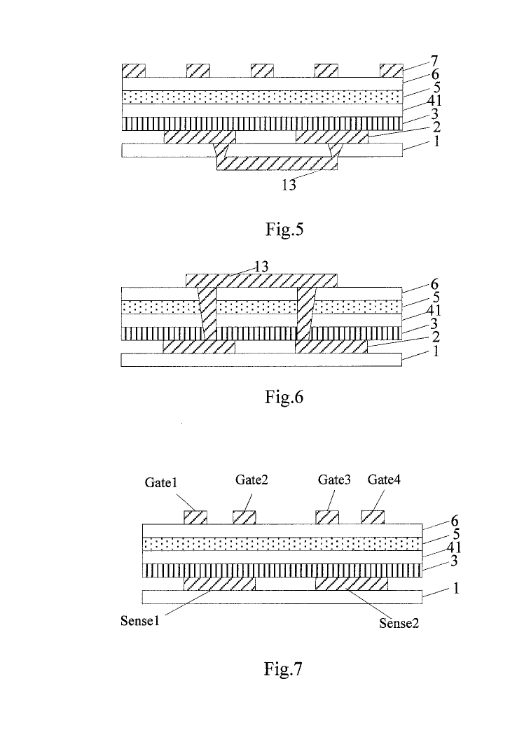

In the case that the adjacent vertical sub-electrodes 11 are connected to each other via the bridge 13 arranged at a layer different from the first pressure sensing electrode, the bridge 13 may be created from the gate metal layer 7, or the source/drain metal layer 8, or a separate metal layer. As shown in FIG. 5, the bridge 13 may be created from a specific metal layer at a side of the base substrate 1 away from the light-shielding metal layer 2. In a possible embodiment of the present disclosure, as shown in FIG. 6, the bridge 13 may be created from the gate metal layer 7.

In a possible embodiment of the present disclosure, the piezoelectric layer is made of polyvinylidene fluoride which is a transparent material. In the case that no electric signal is applied to at least one of the first pressure sensing electrode and the second pressure sensing electrode and no electric field is generated between the first pressure sensing electrode and the second pressure sensing electrode, the piezoelectric layer 3 is equivalent to a transparent insulation layer, so a display effect may not be adversely affected. In the case that an electric signal is applied to each of the first pressure sensing electrode and the second pressure sensing electrode and an electric field is generated between the first pressure sensing electrode and the second pressure sensing electrode, polyvinylidene fluoride may show a piezoelectric characteristic. For example, in the case that a reference voltage of 0V is applied to the first pressure sensing electrode and a reference voltage of 3V is applied to the second pressure sensing electrode, polyvinylidene fluoride may show the piezoelectric characteristic due to a voltage difference. In the case that a pressure is applied to polyvinylidene fluoride, a potential at the first pressure sensing electrode and/or the second pressure sensing electrode may change. At this time, it is able for the pressure detection circuit to detect a size of the applied pressure through detecting the potentials at the first pressure sensing electrode and/or the second pressure sensing electrode.

Of course, the piezoelectric layer 3 may be made of any other transparent material having the piezoelectric characteristic, other than polyvinylidene fluoride.

In a possible embodiment of the present disclosure, a display electrode of the display substrate may also be multiplexed as a touch electrode. In this way, the display substrate may also be provided with a touch function. To be specific, a common electrode of the display substrate may be multiplexed as the touch electrode, and the touch function may be achieved in a time-division driving manner.

Of course, the display substrate in the embodiments of the present disclosure may be of any other type, other than the LTPS TFT array substrate, as long as the original layer pattern of the display substrate is multiplexed as at least one pressure sensing electrode of the pressure sensing structure or the at least one pressure sensing electrode is created from a layer and by a material both identical to the original layer pattern of the display substrate.

The present disclosure further provides in some embodiments a display panel including the above-mentioned display substrate.

The present disclosure further provides in some embodiments a display device including the above-mentioned display panel. The display device may be any product or member having a display function, such as television, display, digital photo frame, mobile phone or flat-panel computer. The display device may further include a flexible circuit board, a printed circuit board and a back plate. In the embodiments of the present disclosure, the display device may be integrated with a pressure detection function.

The present disclosure provides in some embodiments a method for controlling the above-mentioned display device, which includes steps of: applying a first reference electric signal to the first pressure sensing electrode and applying a second reference electric signal to the second pressure sensing electrode, a predetermined voltage difference being provided between the first reference electric signal and the second reference electric signal; and detecting a pressure sensing signal generated on the first pressure sensing electrode and/or the second pressure sensing electrode. In this way, it is able to detect a pressured applied to the display device.

In a possible embodiment of the present disclosure, in the case that the light-shielding metal layer pattern is multiplexed as the first pressure sensing electrode and the gate line or data line of the display substrate is multiplexed as the second pressure sensing electrode, it is necessary to achieve the display and the pressure detection in a time-division manner because a display signal needs to be transmitted via the gate line and the data line. At this time, the method includes: at a display stage within each frame, not applying an electric signal to the first pressure sensing electrode and applying a display electric signal to the second pressure sensing electrode; and at a pressure detection stage within each frame, applying the first reference electric signal to the first pressure sensing electrode, and applying the second reference electric signal to the second pressure sensing electrode.

In other words, during the operation of the display device, each frame is divided into two stages, i.e., the display stage and the pressure detection stage. At the display stage, no electric signal is applied to the first pressure sensing electrode, the display electric signal is applied to the second pressure sensing electrode, and no voltage difference occurs between the first pressure sensing electrode and the second pressure sensing electrode. At this time, the piezoelectric layer 3 is equivalent to a transparent insulation layer, and the display effect may not be adversely affected. At the pressure detection stage, the first reference electric signal is applied to the first pressure sensing electrode, the second reference electric signal is applied to the second pressure sensing electrode, and the voltage difference occurs between the first pressure sensing electrode and the second pressure sensing electrode. At this time, due to the piezoelectric characteristic of the piezoelectric layer 3, it is able to detect a size of the pressure.

In a possible embodiment of the present disclosure, in the case that the light-shielding metal layer pattern for shielding back light from entering a driving TFT of the display substrate is multiplexed as the first pressure sensing electrode , the gate line or data line of the display substrate is multiplexed as the second pressure sensing electrode and the display electrode of the display substrate is multiplexed as the touch electrode, it is necessary to achieve the display, the touch and the pressure detection in a time-division manner. At this time, the method includes: at the display stage within each frame, applying a display voltage signal to the display electrode, not applying an electric signal to the first pressure sensing electrode, and applying a display electric signal to the second pressure sensing electrode; at a touch stage within each frame, applying a touch signal to the display electrode, and not applying an electric signal to the first pressure sensing electrode and the second pressure sensing electrode; and at the pressure detection stage within each frame, not applying an electric signal to the display electrode, applying the first reference electric signal to the first pressure sensing electrode, and applying the second reference electric signal to the second pressure sensing electrode.

In other words, during the operation, each frame is divided into three stages, i.e., the display stage, the touch stage and the pressure detection stage. At the display stage, the display voltage signal is applied to the display electrode, no electric signal is applied to the first pressure sensing electrode, the display electric signal is applied to the second pressure sensing electrode, and no voltage difference occurs between the first pressure sensing electrode and the second pressure sensing electrode. At this time, the piezoelectric layer 3 is equivalent to a transparent insulation layer, and the display effect may not be adversely affected. At the touch stage, the touch signal is applied to the display electrode, no electric signal is applied to the first pressure sensing electrode and the second pressure sensing electrode, the display electrode is capable of performing the touch detection, and no voltage difference occurs between the first pressure sensing electrode and the second pressure sensing electrode. At this time, the piezoelectric layer 3 is equivalent to a transparent insulation layer, and the display effect may not be adversely affected. At the pressure detection stage, no electric signal is applied to the display electrode, the first reference electric signal is applied to the first pressure sensing electrode, the second reference electric signal is applied to the second pressure sensing electrode, and the voltage difference occurs between the first pressure sensing electrode and the second pressure sensing electrode. Due to the piezoelectric characteristic of the piezoelectric layer 3, it is able to detect a size of the pressure.

In the embodiments of the present disclosure, the display device is driven in a time-division manner, so it is able for a pressure sensing unit to be built in the display substrate, i.e., it is unnecessary to attach the pressure sensing unit onto the display device. As a result, it is able to provide the display substrate integrated with the pressure sensing function, thereby to simplify a structure of the display substrate and provide a thin and light display device.

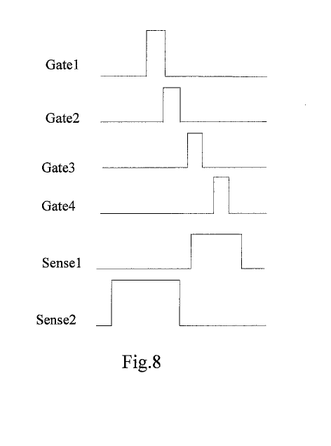

In a possible embodiment of the present disclosure, as shown in FIG. 7, the gate line of the display substrate is multiplexed as the second pressure sensing electrode. To be specific, gate lines Gate1-4 are multiplexed as the second pressure sensing electrodes, and the first pressure sensing electrodes Sense1 and Sense2 are created from the light-shielding metal layer 2. Sense 1 and Gate1-2 form a pressure sensing unit, and Sense 2 and Gate3-4 form another pressure sensing unit. Most of the time, an electric signal applied to the gate lines of the display substrate is at a low level, so the pressure detection may be performed at a stage other than a stage where the electric signal applied to the gate lines is at a high level. As shown in FIG. 8 which is a sequence diagram of the display substrate in FIG. 7, in the case that a high-level electric signal is applied to Gate1-2, no electric signal is applied to Sense1. At this time, the pressure sensing unit consisting of Sense 1 and Gate1-2 may not perform the pressure detection. In the case that a low-level electric signal is applied to Gate1-2, an electric signal is applied to Sense1. At this time, the pressure sensing unit consisting of Sense1 and Gate1-2 may perform the pressure detection. In the case that a high-level electric signal is applied to Gate3-4, no electric signal is applied to Sense2. At this time, the pressure sensing unit consisting of Sense2 and Gate3-4 may not perform the pressure detection. In the case that a low-level electric signal is applied to Gate3-4, an electric signal is applied to Sense. At this time, the pressure sensing unit consisting of Sense2 and Gate3-4 may perform the pressure detection.

In the case that the second pressure sensing electrode is merely created from a layer and by a material both identical to the gate line, it is unnecessary to perform a multiplexing operation in a time-division manner, and instead, it is able to perform the pressure detection and the display simultaneously.

Identically, in the case that the data line of the display substrate is multiplexed as the second pressure sensing electrode, it is necessary to perform the pressure detection at a stage other than a stage where the electric signal applied to the data line is at a high level. In the case that the second pressure sensing electrode is merely created from a layer and by a material both identical to the data line, it is unnecessary to perform a multiplexing operation in a time-division manner, and instead, it is able to perform the pressure detection and the display simultaneously.

Unless otherwise defined, any technical or scientific term used herein shall have the common meaning understood by a person of ordinary skills. Such words as “first” and “second” used in the specification and claims are merely used to differentiate different components rather than to represent any order, number or importance. Similarly, such words as “one” or “one of” are merely used to represent the existence of at least one member, rather than to limit the number thereof. Such words as “connect” or “connected to” may include electrical connection, direct or indirect, rather than to be limited to physical or mechanical connection. Such words as “on”, “under”, “left” and “right” are merely used to represent relative position relationship, and when an absolute position of the object is changed, the relative position relationship will be changed too.

It should be appreciated that, in the case that an element, e.g., a layer, a film, a region or a substrate, is arranged on or under another element, it may be directly arranged on or under the other element, or an additional intermediate element may be arranged therebetween.

The above are merely the preferred embodiments of the present disclosure, but the present disclosure is not limited thereto. Obviously, a person skilled in the art may make further modifications and improvements without departing from the spirit of the present disclosure, and these modifications and improvements shall also fall within the scope of the present disclosure.

What is claimed is:

1. A display substrate, comprising a first conductive pattern arranged on a base substrate, and a pressure sensing structure arranged on the base substrate, wherein the pressure sensing structure comprises a first pressure sensing electrode, a second pressure sensing electrode and a piezoelectric layer arranged between the first pressure sensing electrode and the second pressure sensing electrode; and
the first conductive pattern is multiplexed as the first pressure sensing electrode, or the first conductive pattern is created from a layer and by a material both identical to the first pressure sensing electrode.

2. The display substrate according to claim 1, wherein a driving thin film transistor (TFT) of the display substrate is a Low Temperature Poly-Silicon (LTPS) TFT, and the first conductive pattern is a light-shielding metal layer pattern for shielding back light from entering the driving TFT.

3. The display substrate according to claim 2, further comprising a second conductive pattern arranged at a layer different from the first conductive pattern, wherein the second conductive pattern is multiplexed as the second pressure sensing electrode or the second conductive pattern is created from a layer and by a material both identical to the second pressure sensing electrode.

4. The display substrate according to claim 3, wherein the second conductive pattern is a gate line or data line of the display substrate, or created from a layer and by a material both identical to agate line or data line of the display substrate.

5. The display substrate according to claim 2, wherein the first pressure sensing electrode comprises rectangular or triangular sub-electrodes arranged in a matrix form.

6. The display substrate according to claim 2, wherein the first pressure sensing electrode comprises lateral sub-electrodes arranged in rows and vertical sub-electrodes arranged in columns, the adjacent lateral sub-electrodes are connected to each other via a conductive line arranged at a layer identical to the first pressure sensing electrode, and the adjacent vertical sub-electrodes are connected to each other via a bridge arranged at a layer different from the first pressure sensing electrode.

7. The display substrate according to claim 6, wherein the bridge is created from a gate metal layer or a source/drain metal layer.

8. The display substrate according to claim 6, wherein the bridge is created from a separate metal layer.

9. The display substrate according to claim 1, wherein the piezoelectric layer is made of polyvinylidene fluoride.

10. The display substrate according to claim 1, further comprising a display electrode multiplexed as a touch electrode.

11. A display substrate, comprising, from bottom to top, a base substrate, a light-shielding metal layer, a piezoelectric layer, an insulation layer, an active layer, a gate insulation layer, and a gate metal layer, wherein the piezoelectric layer is in contact with the light-shielding metal layer, and the light-shielding metal layer, the piezoelectric layer and the gate metal layer form a pressure sensing structure.

12. A display panel, comprising the display substrate according to claim 1.

13. A display device, comprising the display panel according to claim 12.

14. A method for controlling the display device according to claim 13, comprising steps of:
applying a first reference electric signal to the first pressure sensing electrode and applying a second reference electric signal to the second pressure sensing electrode, a predetermined voltage difference being provided between the first reference electric signal and the second reference electric signal; and
detecting a pressure sensing signal generated on the first pressure sensing electrode and/or the second pressure sensing electrode.

15. The method according to claim 14, wherein a light-shielding metal layer pattern is multiplexed as the first pressure sensing electrode and a gate line or data line of the display substrate is multiplexed as the second pressure sensing electrode, the method comprises:
at a display stage within each frame, not applying an electric signal to the first pressure sensing electrode and applying a display electric signal to the second pressure sensing electrode; and
at a pressure detection stage within each frame, applying the first reference electric signal to the first pressure sensing electrode, and applying the second reference electric signal to the second pressure sensing electrode.

16. The method according to claim 14, wherein a light-shielding metal layer pattern for shielding back light from entering a driving TFT of the display substrate is multiplexed as the first pressure sensing electrode, a gate line or data line of the display substrate is multiplexed as the second pressure sensing electrode and a display electrode of the display substrate is multiplexed as a touch electrode, the method comprises:
at a display stage within each frame, applying a display voltage signal to the display electrode, not applying an electric signal to the first pressure sensing electrode, and applying a display electric signal to the second pressure sensing electrode;
at a touch stage within each frame, applying a touch signal to the display electrode, and not applying an electric signal to the first pressure sensing electrode and the second pressure sensing electrode; and
at a pressure detection stage within each frame, not applying an electric signal to the display electrode, applying the first reference electric signal to the first pressure sensing electrode, and applying the second reference electric signal to the second pressure sensing electrode.
